(19) United States
(12) Patent Application Publication
(10) Pub. No.: US 2015/0234242 A1
(43) Pub. Date: Aug. 20, 2015

(54) DISPLAY DEVICE

(71) Applicant: Samsung Display Co., Ltd., Yongin-City (JP)

(72) Inventors: Daisuke INOUE, Cheonan-si (KR); CHANG-HUN LEE, Hwaseong-si (KR); TAEHO KIM, Asan-si (KR); MiSuk KIM, Cheonan-si (KR); Soyoun PARK, Hwaseong-si (KR)

(21) Appl. No.: 14/595,539

(22) Filed: Jan. 13, 2015

(30) Foreign Application Priority Data
Feb. 19, 2014 (KR) 10-2014-0019161

(51) Int. Cl. G02F 1/1343; G02F 1/1333; G02F 1/1362; G02F 1/1335; G02F 1/1368

(52) U.S. Cl. CPC G02F 1/134336; G02F 1/133512; G02F 1/1368; G02F 1/136227; G02F 1/133345; G02F 1/133514

(57) ABSTRACT

A display device includes a display panel including pixels, pixel electrodes disposed in pixel areas corresponding to the pixels, arranged at a first distance from each other along a first direction, and extending in a second direction crossing the first direction, and a black matrix disposed in a non-pixel area adjacent to each pixel area, where a width of the black matrix between the pixel areas and the first distance are set to allow a variation rate of brightness of each pixel arranged in a same pixel column and a pixel row to be in a range from about +2% to about −2% when a gray-scale level of the pixels respectively disposed at left and right sides of each pixel arranged in the same pixel column is changed to a different gray-scale level in the pixel row from a gray-scale level in a previous pixel row.

This application claims priority to Korean Patent Application No. 10-2014-0019161, filed on Feb. 19, 2014, and all the benefits accruing therefrom under 35 U.S.C. §119, the content of which in its entirety is herein incorporated by reference.

### BACKGROUND

1. Field

The disclosure relates to a display device. More particularly, the disclosure relates to a display device with reduced variation in brightness of a pixel.

2. Description of the Related Art

A liquid crystal display includes pixels to display an image. The pixels receive data voltages in response to gate signals and display gray scales corresponding to data voltages.

The liquid crystal display typically includes two substrates facing each other and a liquid crystal layer interposed between the two substrates. Liquid crystal molecules of the liquid crystal layer are driven by the data voltages. A transmittance of light passing through the liquid crystal layer is controlled by the liquid crystal molecules driven by the data voltages.

Each pixel includes a pixel area in which the image is displayed and a non-pixel area disposed adjacent to the pixel areas. A black matrix is typically disposed in the non-pixel area to block the light traveling to the non-pixel area, which is unnecessary to display the image.

### SUMMARY

The disclosure provides a display device in which a variation in brightness of a pixel, which is caused by a variation in gray-scale level of adjacent pixels to the pixel, is substantially reduced.

Exemplary embodiments of the invention provide a display device including a display panel including a plurality of pixels arranged substantially in a matrix form, a plurality of pixel electrodes disposed in pixel areas corresponding to the pixels, arranged at a first distance from each other along a first direction, and extending in a second direction crossing the first direction, and a black matrix disposed in a non-pixel area disposed adjacent to each pixel area. In such an embodiment, a width of the black and the first distance are set to allow a variation rate of a brightness of each pixel arranged in a same pixel column and a pixel row to be in a range from about +2% to about −2% when a gray-scale level of the pixels respectively disposed at left and right sides of each pixel arranged in the same pixel column is changed to a different gray-scale level in the pixel row from a gray-scale level in a previous pixel row, and the width of the black matrix is defined as a width of the black matrix between the pixel areas in the first direction or the second direction.

In an exemplary embodiment, a gray-scale level of each pixel arranged in the same pixel column and in the pixel row may be equal to a gray-scale level of each pixel arranged in the same pixel column and in the previous pixel row.

In an exemplary embodiment, each of the pixel electrodes may include a branch portion extending in the second direction and disposed at a center of the pixel area.

In an exemplary embodiment, the display panel may include a first substrate, on which the pixels are arranged, a second substrate comprising color filters corresponding to the pixels and the black matrix, wherein the black matrix is arranged on the second substrate, and a liquid crystal layer disposed between the first substrate and the second substrate.

In an exemplary embodiment, the pixels may receive positive and negative data voltages in response to gate signals sequentially applied thereto and be driven in the unit of row, and a polarity of the pixels may be inverted in the unit of row.

In an exemplary embodiment, the liquid crystal layer may include negative liquid crystal molecules, the first distance may be equal to or smaller than about 14 micrometers, and the width of the black matrix may be equal to or smaller than about 6 micrometers.

In an exemplary embodiment, the liquid crystal layer includes positive liquid crystal molecules, the first distance may be equal to or larger than about 10.6 micrometers, and the width of the black matrix may be equal to or larger than about 4 micrometers.

In an exemplary embodiment, the pixels may receive positive and negative data voltages in response to gate signals sequentially applied thereto and be driven in the unit of row, and a polarity of the pixels may be inverted in row and column directions.

In an exemplary embodiment, the liquid crystal layer may include negative liquid crystal molecules, the first distance may be equal to or larger than about 8 micrometers, and the width of the black matrix may be equal to or smaller than about 6 micrometers and equal to or larger than about 4 micrometers.

In an exemplary embodiment, the liquid crystal layer may include positive liquid crystal molecules, the first distance may be equal to or larger than about 12.6 micrometers, and the width of the black matrix may be equal to or smaller than about 7 micrometers and equal to or larger than about 5 micrometers.

In an exemplary embodiment, the liquid crystal layer may include positive liquid crystal molecules, the first distance may be equal to or larger than about 10.2 micrometers and equal to or smaller than about 10.6 micrometer, and the width of the black matrix may be equal to or smaller than about 7 micrometers and equal to or larger than about 5 micrometers.

In an exemplary embodiment, each of the pixels may include a thin film transistor connected to a corresponding pixel electrode of the pixel electrodes, an organic insulating layer disposed to cover the thin film transistor, a common electrode disposed on the organic insulating layer and including an opening portion, and an inorganic insulating layer disposed on the organic insulating layer to cover the common electrode. In such an embodiment, the pixel electrode may be disposed on the inorganic insulating layer, the corresponding pixel electrode may be connected to the thin film transistor through a contact hole defined through the organic insulating layer and the inorganic insulating layer, and the opening portion may overlap the contact hole and have a size greater than a size of the contact hole when viewed in a plan view.

According to exemplary embodiments described herein, the display device may minimize the variation rate of the brightness of the pixel with respect to the variation in the gray-scale level of the peripheral pixel.

### BRIEF DESCRIPTION OF THE DRAWINGS

The above and other features of the disclosure will become readily apparent by reference to the following detailed description when considered in conjunction with the accompanying drawings, in which:

FIG. 1 is a plan view showing an exemplary embodiment of a display device according to the disclosure;

FIG. 2 is a plan view showing an exemplary embodiment of a pixel shown in FIG. 1;

FIGS. 3A and 3B are views showing alternative exemplary embodiment of a pixel electrode having different shapes from that of an exemplary embodiment of a pixel electrode shown in FIG. 2;

FIG. 4 is a cross-sectional view taken along line I-I′ shown in FIG. 2;

FIGS. 5 and 6 are views showing a driving state of the pixels shown in FIG. 1;

FIG. 7 is a view showing a variation in gray-scale level of a peripheral pixel of the pixel shown in FIG. 1; and

FIGS. 8 to 11 are views showing experimental results showing a brightness variation rate of the pixel shown in FIG. 2 with respect to the variation in gray-scale level of the peripheral pixel.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings herein.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

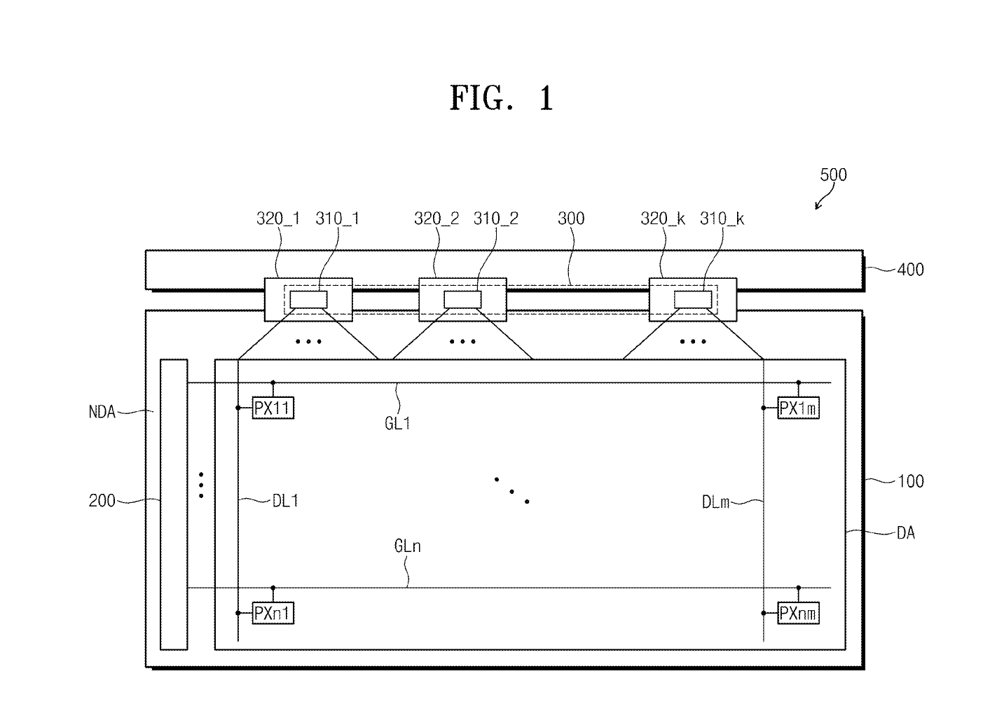

FIG. 1 is a plan view showing an exemplary embodiment of a display device according to the disclosure.

Referring to FIG. 1, an exemplary embodiment of a display device 500 includes a display panel 100, a gate driver 200, a data driver 300 and a driving circuit board 400.

The display panel 100 includes a plurality of pixels PX11 to PXnm, a plurality of gate lines GL1 to GLn, and a plurality of data lines DL1 to DLm. The display panel 100 includes a display area DA and a non-display area NDA disposed adjacent to the display area DA when viewed in a plan view.

The pixels PX11 to PXnm are arranged substantially in a matrix form in the display area DA. In one exemplary embodiment, for example, the pixels PX11 to PXnm are arranged in n rows by m columns. Here, each of “m” and “n” is a positive integer greater than zero (0).

The gate lines GL1 to GLn are insulated from the data lines DL1 to DLm while crossing the data lines DL1 to DLm. The gate lines GL1 to GLn are connected to the gate driver 200 to sequentially receive gate signals. The data lines DL1 to DLm are connected to the data driver 300 to receive data voltages in analog form.

Each of the pixels PX11 to PXnm is connected to a corresponding gate line of the gate lines GL1 to GLn and a corresponding data line of the data lines DL1 to DLm. The pixels PX11 to PXnm receive the data voltages through the data lines DL1 to DLm in response to the gate signals applied through the gate lines GL1 to GLn. The pixels PX11 to PXnm display gray scales corresponding to the data voltages.

The gate driver 200 generates the gate signals in response to a gate control signal applied from a timing controller (not shown), which may be disposed or mounted on the driving circuit board 400. The gate signals are sequentially applied to the pixels PX11 to PXnm through the gate lines GL1 to GLn in the unit of row or on a row-by-row basis, such that the pixels PX11 to PXnm are driven in the unit of row or on a row-by-row basis.

The gate driver 200 is disposed in the non-display area NDA disposed adjacent to a left side of the display area DA. In an exemplary embodiment, the gate driver 200 is disposed in the non-display area NDA disposed adjacent to the left side of the display area DA in an amorphous silicon TFT gate driver circuit (“ASG”) manner, but the invention is not limited thereto or thereby.

In one exemplary embodiment, for example, the gate driver 200 may include a plurality of driving chips. The gate driving chips are mounted on the non-display area NDA adjacent to the left side of the display area DA in a chip on glass (“COG”) manner or connected to the non-display area NDA in a tape carrier package (“TCP”) manner.

The data driver 300 receives image signals and a data control signal from the timing controller. The data driver 300 generates the data voltages in analog form, which correspond to the image signals, in response to the data control signal. The data driver 300 applies the data voltages to the pixels PX11 to PXnm through the data lines DL1 to DLm.

The data driver 300 includes a plurality of source driving chips 310_1 to 310_k. Here, “k” is a positive integer greater than zero (0) and less than “m”. Each of the source driving chips 310_1 to 310_k is disposed or mounted on a corresponding flexible circuit board of flexible circuit boards 320_1 to 320_k and connected between the driving circuit board 400 and the non-display area NDA disposed adjacent to an upper portion of the display area DA.

In an exemplary embodiment, the data driver 300 may be connected to the display panel 100 in the tape carrier package (“TCP”) manner. However, the invention is not limited thereto or thereby. In an alternative exemplary embodiment, the source driving chips 310_1 to 310_k may be disposed or mounted in the non-display area NDA disposed adjacent to the upper portion of the display area DA in the chip-on-glass (“COG”) manner.

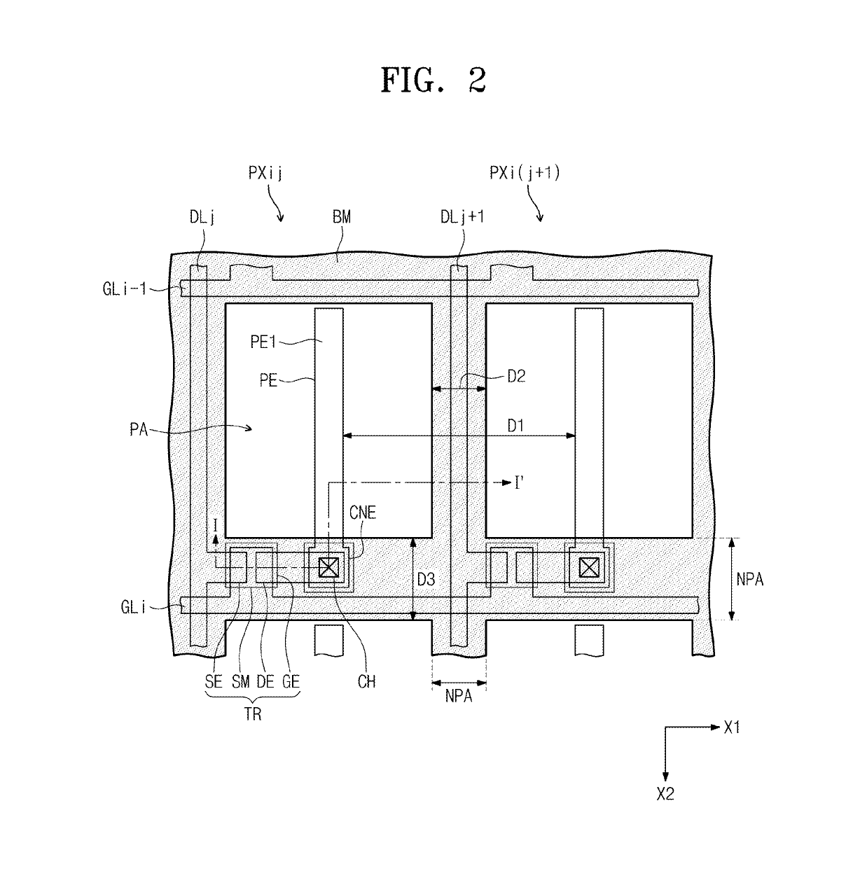

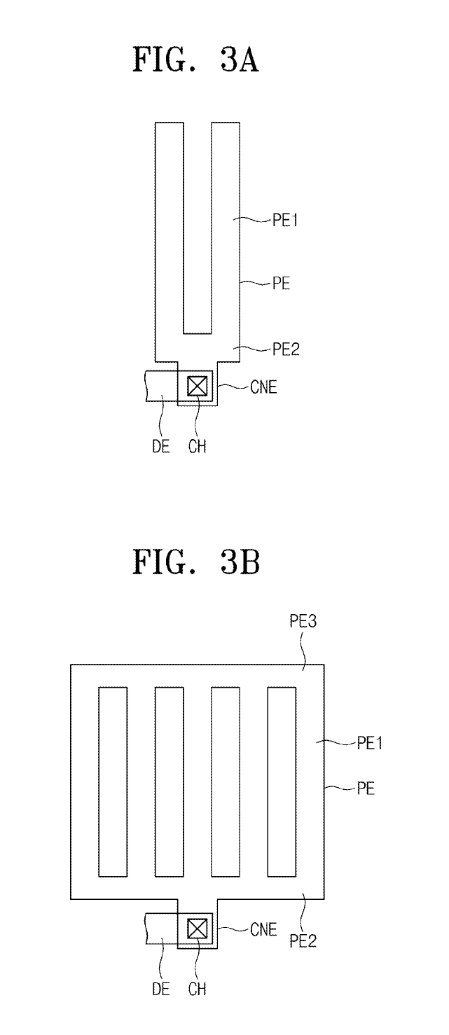

FIG. 2 is a plan view showing an exemplary embodiment of the pixel shown in FIG. 1, and FIGS. 3A and 3B are views showing exemplary embodiments of pixel electrodes having a different shape from a shape of a pixel electrode shown in FIG. 2.

For the convenience of illustration, FIG. 2 shows only two pixels PXij and PXi(j+1), and the other pixels may have the same configuration as the two pixels PXij and PXi(j+1). Hereinafter, only one pixel PXij will be described in greater detail.

Referring to FIGS. 2, 3A, and 3B, the pixel PXij includes a pixel area PA and a non-pixel area NPA disposed adjacent to the pixel area PA when viewed in a plan view. The image is displayed in the pixel area PA and not displayed in the non-pixel area NPA.

The non-pixel area NPA corresponds to an area between the pixel areas PA. Accordingly, the pixels PX11 to PXnm include the pixel areas PA corresponding to the pixels PX11 to PXnm and the non-pixel area NPA between the pixel areas PA.

The gate lines GLi−1 and GLi and the data lines DLj and DLj+1 are disposed in the non-pixel area NPA. The gate lines GLi−1 and GLi extend substantially in a first direction X1. The data lines DLj and DLj+1 extend substantially in a second direction X2 different from the first direction X1 and are insulated from the gate lines GLi−1 and GLi while crossing the gate lines GLi−1 and GLi. Herein, “i” is a positive integer greater than zero (0) or equal to or less than “n”, and “j” is a positive integer greater than zero (0) or equal to or less than “m”.

The pixel PXij includes a transistor TR and a pixel electrode PE connected to the transistor TR. The transistor TR is disposed in the non-pixel area NPA. The pixel electrode PE is disposed in the pixel area PA. The transistor TR of the pixel PXij is connected to the corresponding gate line GLi and the corresponding data line DLj.

The transistor TR includes a gate electrode GE connected to the gate line GLi, a source electrode SE connected to the data line DLj, a drain electrode DE connected to the pixel electrode PE, and a semiconductor layer SM in which a conductive channel between the source electrode SE and the drain electrode DE is formed.

In an exemplary embodiment, the gate electrode GE is branched from the gate line GLi, and the source electrode SE is branched from the data line DLj. The drain electrode DE is disposed to be spaced apart from the source electrode SE. The drain electrode DE extends and is electrically connected to the pixel electrode PE through a contact hole CH. The pixel electrode PE extends substantially in the second direction X2 and is disposed at a center of the pixel area PA. The pixel electrode PE extends to the non-pixel area NPA and is connected to the drain electrode DE of the transistor TR through the contact hole CH. In an exemplary embodiment, a connection electrode CNE branched from the pixel electrode PE is connected to the drain electrode DE of the transistor TR through the contact hole CH. The connection electrode CNE is disposed in the non-pixel area NPA.

The pixel electrode PE includes one branch portion PE1 extending in the second direction X2. The branch portion PE1 is disposed at the center of the pixel area PA. The connection electrode CNE is branched from the branch portion PE1.

The pixel electrode PE shown in FIG. 2 includes one branch portion PE1, but the shape of the pixel electrode PE should not be limited thereto or thereby.

In one alternative exemplary embodiment, for example, the pixel electrode PE may include a plurality of branches PE1 and a first connection portion PE2 as shown in FIG. 3A. In such an embodiment, the branch portions PE1 are arranged in the first direction X1 at a regular interval and extend substantially in the second direction X2. The first connection portion PE2 connects lower portions of the branch portions PE1 to each other.

FIG. 3A shows only two branch portions PE1, but the number of the branch portions PE1 should not be limited to two.

In an alternative exemplary embodiment, the pixel electrode PE may include a plurality of branch portions PE1, a first connection portion PE2 and a second connection portion PE3. The branch portions PE1 are arranged substantially in the first direction X1 at a regular interval and extend substantially in the second direction X2. The first and second connection portions PE2 and PE3 extend substantially in the first direction Xl.

The first connection portion PE2 connects ends of the branch portions PE1 to each other in the second direction X2, and the second connection portion PE3 connects the other ends of the branch portions PE1 to each other in the second direction X2.

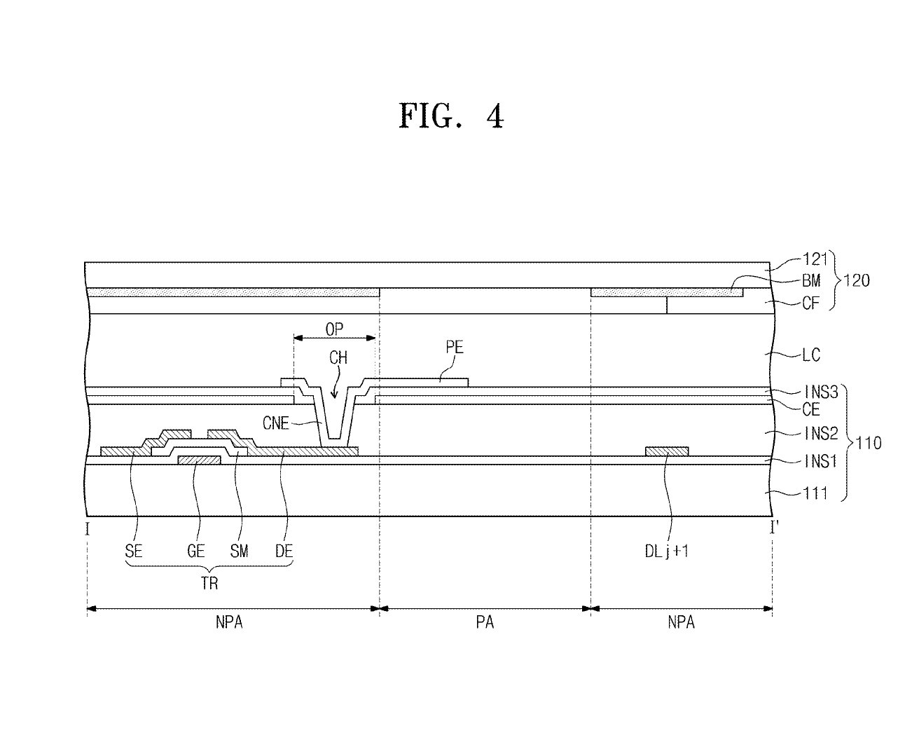

In an exemplary embodiment, a common electrode (not shown) may be disposed in the pixel PXij. The common electrode includes an opening portion having a size greater than a size of the contact hole CH when viewed in a plan view. The common electrode will be described in greater detail with reference to FIG. 4.

A black matrix BM is disposed in the non-pixel area NPA. The black matrix BM blocks light leakage from the non-pixel area NPA.

In an exemplary embodiment, when a distance in the first direction X1 between the pixel electrodes PE adjacent to each other, a width in the first direction X1 of the black matrix BM between the pixel areas PA, and a width in the second direction X2 of the black matrix BM between the pixel areas PA are referred to as first, second and third distances D1, D2, and D3, respectively, the first distance D1 is larger than the second and third distances D2 and D3. For the convenience of illustration, the second distance D2 is shown to be smaller than the third distance D3 in FIG. 2, but the second distance D2 may be substantially the same as the third distance D3. In an exemplary embodiment, the second distance D2 may be smaller than or substantially the same as the third distance D3.

A brightness of the pixel PXij may vary based on a variation in gray-scale level of a pixel adjacent to the pixel PXij. A variation rate of the brightness of the pixel PXij varies depending on the distance between adjacent pixel electrodes PE to each other and the width of the black matrix BM. That is, the variation rate of the brightness of the pixel PXij varies based on the first distance D1, the second distance D2 and the third distance D3.

In an exemplary embodiment, the first distance D1, the second distance D2 and the third distance D3 may be set to allow the variation rate of the brightness of the pixel PXij to be in a range from about +2% to −2%, which will be described later in greater detail.

FIG. 4 is a cross-sectional view taken along line I-I′ shown in FIG. 2.

Referring to FIG. 4, the display panel 100 includes a first substrate 110, a second substrate 120 disposed to face the first substrate 110, and a liquid crystal layer LC disposed between the first substrate 110 and the second substrate 120. The pixels PX11 to PXnm may be disposed on the first substrate 110.

The first substrate 110 includes a first base substrate 111, the transistor TR, first, second and third insulating layers INS1, INS2 and INS3, the common electrode CE, and the pixel electrode PE.

The first base substrate 111 includes the display area DA and the non-display area NDA disposed adjacent to the display area DA, and the display area DA of the first base substrate 111 includes the pixel areas PA and the non-pixel area NPA disposed between the pixel areas PA.

The gate electrode GE of the transistor TR is disposed on the first base substrate 111 in the non-pixel area NPA. The first insulating layer INS1 is disposed on the first base substrate 111 to cover the gate electrode GE. The first insulating layer INS 1 includes an inorganic material. The first insulating layer INS 1 may be referred to as a gate insulating layer.

The semiconductor layer SM of the transistor TR is disposed on the first insulating layer INS1 in the non-pixel area NPA. A predetermined area of a center of the semiconductor layer SM overlaps the gate electrode GE when viewed in a plan view. In an exemplary embodiment, the semiconductor layer SM includes an active layer (not shown) and an ohmic contact layer (not shown).

The source electrode SE and the drain electrode DE are disposed on the semiconductor layer SM and spaced apart from each other. The semiconductor layer SM forms the conductive channel between the source electrode SE and the drain electrode DE. The data line DLj+1 is disposed on the first insulating layer INS1 in the non-pixel area NPA.

The second insulating layer INK is disposed on the first insulating layer INS1 to cover the transistor TR and the data line DLj+1. The second insulating layer INS2 may be an organic insulating layer including an organic material.

In an exemplary embodiment, a passivation layer (not shown) may be disposed between the first insulating layer INS1 and the second insulating layer INS2 to cover the transistor TR and the data line DLj+1. The passivation layer includes an inorganic material and covers an upper portion of the semiconductor layer SM, which is exposed.

The common electrode CE is disposed on the second insulating layer INS2. The common electrode CE includes the opening portion OP disposed in the non-pixel area NPA. The common electrode CE is not formed in the opening portion OP. The opening portion OP is defined in the common electrode CE to overlap the contact hole CH. The size of the opening portion OP is greater than the size of the contact hole CH when view in a plan view.

The common electrode CE includes a transparent conductive material. In one exemplary embodiment, for example, the common electrode CE includes a transparent conductive metal oxide, such as indium tin oxide (“ITO”), indium zinc oxide (“IZO”), indium tin zinc oxide (“ITZO”), etc.

The third insulating layer INS3 is disposed on the second insulating layer INS2 to cover the common electrode CE. The third insulating layer INS3 may be an inorganic insulating layer including an inorganic material.

The contact hole CH is defined through the second and third insulating layers INS2 and INS3 to expose a portion of the drain electrode DE of the transistor TR. The contact hole CH is positioned to overlap the opening portion OP of the common electrode CE. As described above, the size of the contact hole CH is smaller than the size of the opening portion OP when viewed in a plan view.

The pixel electrode PE is disposed on the third insulating layer INS3 in the pixel area PA. The pixel electrode PE is electrically insulated from the common electrode CE by the third insulating layer INS3. The pixel electrode PE is electrically connected to the drain electrode DE of the transistor TR through the contact hole CH.

In an exemplary embodiment, the connection electrode CNE branched from the pixel electrode PE is electrically connected to the drain electrode DE of the transistor TR through the contact hole CH in the non-pixel area NPA. Therefore, the transistor TR may be electrically connected to the pixel electrode PE.

The opening portion OP of the common electrode CE overlaps the contact hole CH and has the size greater than the size of the contact hole CH when viewed in a plan view, such that the pixel electrode PE is not shorted to the common electrode CE when the connection electrode CNE branched from the pixel electrode PE is connected to the drain electrode DE through the contact hole CH.

The pixel electrode PE and the connection electrode CNE include a transparent conductive material. In one exemplary embodiment, for example, the pixel electrode PE and the connection electrode CNE include a transparent conductive metal oxide, e.g., ITO, IZO, ITZO, etc.

The second substrate 120 includes a second base substrate 121, the black matrix BM, and a plurality of color filters CF. The second base substrate 121 is disposed to face the first base substrate 111.

The black matrix BM is disposed under the second base substrate 121 in the non-pixel area NPA. The color filters CF are disposed under the second base substrate 121 to respectively correspond to the pixels PX11 to PXnm. The color filters CF are disposed to cover the black matrix BM.

Each color filter CF allows the light passing through the pixel PXij to have a predetermined color. Each color filter CF may be one of a red color filter, a green color filter, and a blue color filter.

The black matrix BM blocks the light leakage in the non-pixel area NPA. The black matrix BM effectively prevents light leakage caused by malfunction of the liquid crystal molecules in edges of the pixel area PA or colors from mixing in edges of the color filter CF.

The liquid crystal layer LC includes positive liquid crystal molecules or negative liquid crystal molecules. When a dielectric constant in a longitudinal axis (e.g., a long or major axis) of the liquid crystal molecule is less than a dielectric constant in a transverse axis (e.g., a short or minor axis) of the liquid crystal molecules, the liquid crystal layer LC may be a negative liquid crystal layer. When the dielectric constant in the longitudinal axis of the liquid crystal molecule is greater than the dielectric constant in the transverse axis of the liquid crystal molecules, the liquid crystal layer LC may be a positive liquid crystal layer.

The display device 500 including the pixel electrode PE and the common electrode CE arranged as shown in FIGS. 3 and 4 may be a plane to line switching (“PLS”) mode liquid crystal display device.

The transistor TR is turned on in response to the gate signal provided through the corresponding gate line GLi. The turned-on transistor TR receives the data voltage from the corresponding data line DLj and applies the data voltage to the pixel electrode PE. The common electrode CE receives a common voltage.

In the PLS mode liquid crystal display device, a fringe electric field is formed by the pixel electrode PE applied with the data voltage and the common electrode CE applied with the common voltage. In the PLS mode, the liquid crystal molecules of the liquid crystal layer LC are driven by the fringe electric field. Due to the liquid crystal molecules driven by the fringe electric field, a transmittance of the light passing through the liquid crystal layer LC is controlled, and thus desired images are displayed.

When the liquid crystal layer LC is the positive liquid crystal layer, the liquid crystal molecules are driven such that the longitudinal axis of the liquid crystal molecules is oriented to be substantially vertical, e.g., about 90 degrees, to the pixel electrode PE and the common electrode CE. When the liquid crystal layer LC is the negative liquid crystal layer, the liquid crystal molecules are driven such that the longitudinal axis of the liquid crystal molecules is oriented to be substantially parallel to the pixel electrode PE and the common electrode CE.

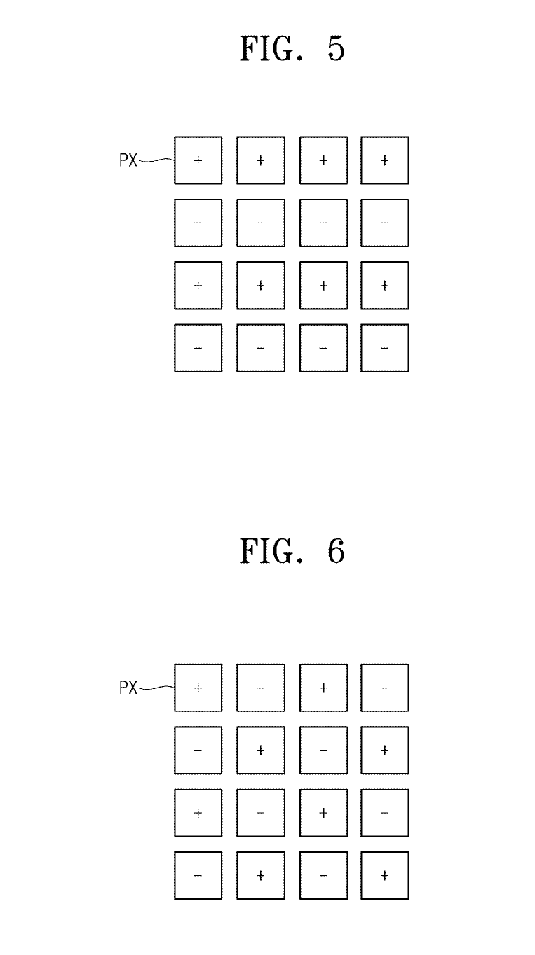

FIGS. 5 and 6 are views showing a driving state of the pixels shown in FIG. 1.

For the convenience of illustration, FIGS. 5 and 6 show the pixels PX arranged in four rows by four columns.

Referring to FIG. 5, in an exemplary embodiment, the pixels PX may be driven in a row-inversion driving manner. In such an embodiment, a polarity of the pixels PX is inverted in the unit of row.

In an exemplary embodiment, the gate signals are sequentially applied to the pixels PX. The pixels PX receive the gate signals in the unit of row. Each of the data voltages has a positive or negative polarity. The pixels PX are sequentially driven in the unit of row by the gate signals.

The pixels PX receive the data voltages in response to the gate signals. The polarity of the data voltages applied to the pixels PX through the data lines DL1 to DLm is inverted in the unit of row.

In one exemplary embodiment, for example, the pixels PX arranged in a first row receive the positive data voltages through the data lines DL1 to DLm in response to a first gate signal. The pixels PX arranged in the first row are charged with the pixel voltage corresponding to the positive data voltages. In FIGS. 5 and 6, the pixels PX charged with the pixel voltage corresponding to the positive data voltages are shown as positive pixels (+).

The pixels PX arranged in a second row following the first row receive the negative data voltages through the data lines DL1 to DLm in response to a second gate signal. The pixels PX arranged in the second row are charged with the pixel voltage corresponding to the negative data voltages. In FIGS. 5 and 6, the pixels PX charged with the pixel voltage corresponding to the negative data voltages are shown as negative pixels (−).

When the operation of the pixels PX described above is repeated, the pixels PX are driven in the row-inversion driving manner as shown in FIG. 5.

Referring to FIG. 6, the pixels PX may be driven in a dot-inversion driving manner. That is, the polarity of the pixels PX is inverted in row and column directions, e.g., ever pixel row and every pixel column.

In an exemplary embodiment, the polarity of the data voltages applied to the pixels PX through the data lines DL1 to DLm is inverted in the unit of row and column. In one exemplary embodiment, for example, the pixels PX arranged in the first row receive the positive and negative data voltages through the data lines DL1 to DLm in response to the first gate signal.

The pixels PX arranged in the second row following the first row receive the negative and positive data voltages through the data lines DL1 to DLm in response to the second gate signal. When the operation of the pixels PX described above is repeated, the pixels PX are driven in the dot-inversion driving manner as shown in FIG. 6.

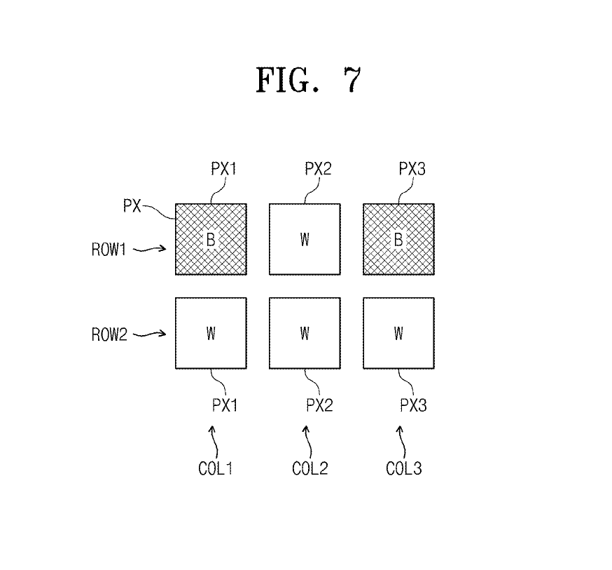

FIG. 7 is a view showing a variation in gray-scale level of a peripheral pixel of the pixel shown in FIG. 1.

For the convenience of illustration, FIG. 7 shows the pixels PX1, PX2, and PX3 arranged in two rows ROW1 and ROW2 by three columns COL1, COL2 and COL3.

Referring to FIG. 7, first, second and third pixels PX1, PX2 and PX3 are sequentially arranged in each of the first and second rows ROW1 and ROW2.

The first pixels PX1 are arranged in the first column COL1, the second pixels PX2 are arranged in the second column COL2, and the third pixels PX3 are arranged in the third column COL3.

When a pixel PX is in the second pixel column COL2, e.g., the second pixels PX2, the first and third pixels PX1 and PX3 respectively disposed at left and right sides of the second pixels PX2 may be referred to as peripheral pixels PX.

The pixels PX arranged in the first row ROW1 may be referred to as previous pixels PX, and the pixels PX arranged in the second row ROW2 may be referred to as present pixels PX.

In an exemplary embodiment, as described above, the pixels PX are sequentially driven in the unit of row. Accordingly, the pixels PX arranged in the second row ROW2 are driven after the pixels PX arranged in the first row ROW1 are driven.

The gray-scale level of the peripheral pixels PX disposed at a side, e.g., a left side or a right side, of each of the pixels PX arranged in the same pixel column, e.g., the second column COL2, may be different from each other in the first and second rows ROW1 and ROW2. Hereinafter, the same pixel column indicates the second column COL2.

In an exemplary embodiment, the second pixel PX2 arranged in the first row ROW1 may display a white gray scale, and the first and third pixels PX1 and PX3 may display a black gray scale. The second pixel PX2 arranged in the second row ROW2 may display the white gray scale, and the first and third pixels PX1 and PX3 may display the white gray scale.

Therefore, in such an embodiment, the gray-scale level of the pixel PX2 does not vary in the first and second rows ROW1 and ROW2, but the gray-scale level of the first and third pixels PX1 and PX3 varies to the white gray scale from the black gray scale. That is, the gray-scale level of the first and third pixels PX1 and PX3 respectively disposed at left and right sides of each of the second pixels PX2 arranged in the second column COL2 varies in the first and second rows ROW1 and ROW2.

When the gray-scale level of the first and third pixels PX1 and PX3 respectively disposed at left and right sides of each of the second pixels PX2 arranged in the second column COL2 varies in the first and second rows ROW1 and ROW2, the brightness of the second pixel PX2 arranged in the second row ROW2 is changed by the first and third pixels PX1 and PX3 that display the black gray scale in the first row ROW1 and the white gray scale in the second row ROW2.

The black gray scale corresponds to a minimum gray-scale level displayed by the pixels PX, and the white gray scale corresponds to a maximum gray-scale level displayed by the pixels PX. The variation rate of the brightness of the second pixel PX2 is substantially proportional to a degree of the variation in the gray-scale level of the first and third pixels PX1 and PX3 corresponding to the peripheral pixels PX.

Thus, when the gray-scale level of the first and third pixels PX1 and PX3 is changed to the white gray scale from the black gray scale in the first and second rows ROW1 and row ROW2, the variation rate of the brightness of the second pixel PX2 of the second row ROW2 may be the greatest variation rate.

When the gray-scale level of the first and third pixels PX1 and PX3 is changed to the a gray scale between the black and white gray scales from the black gray scale in the first and second rows ROW1 and row ROW2, the variation rate of the brightness of the second pixel PX2 arranged in the second row ROW2 becomes less.

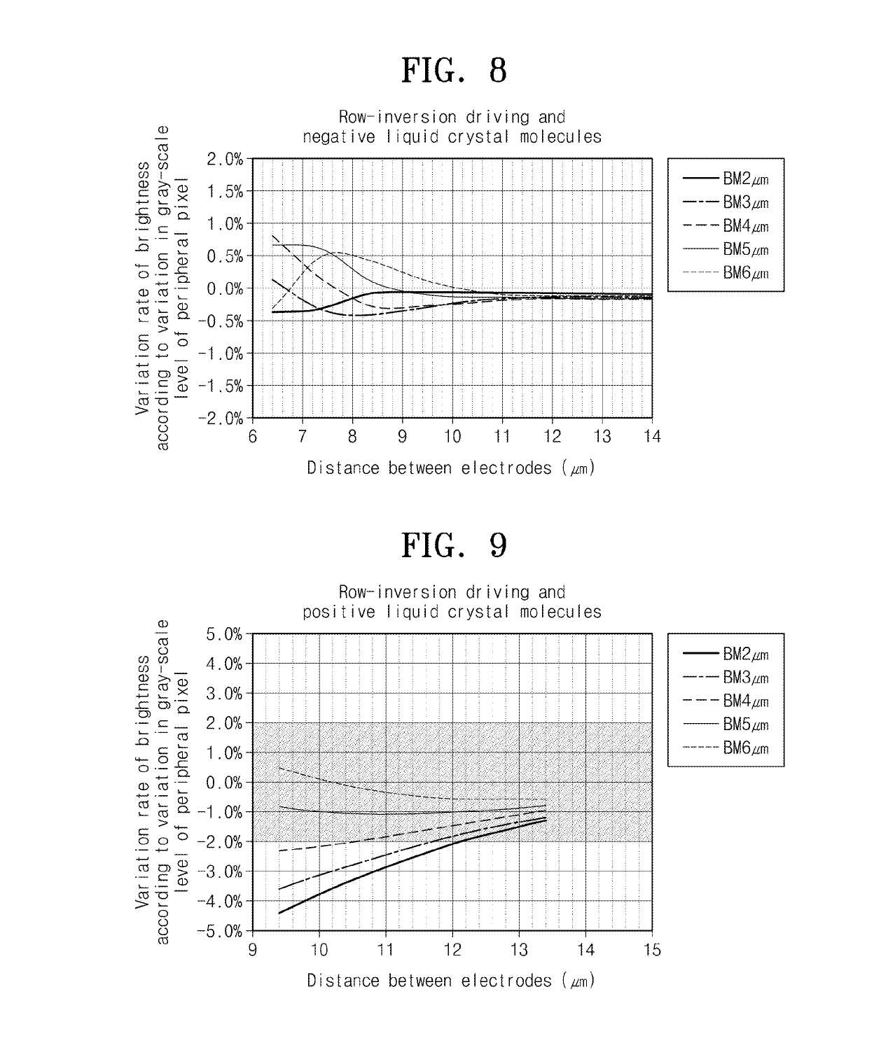

FIGS. 8 to 11 are views showing experimental results of the variation rate of the brightness of the pixel shown in FIG. 2 in accordance with the variation in gray-scale level of the peripheral pixels.

Graphs shown in FIGS. 8 to 11 represent the variation in brightness of the second pixel PX2 arranged in the second row ROW2 when the gray-scale level of the first and third pixels PX1 and PX3 is changed to the white gray scale in the second row ROW2 from the black gray scale in the first row ROW1. As described above, the gray-scale level of the second pixel PX2 is not changed in the first and second rows ROW1 and ROW2.

As described above, when the gray-scale level of the first and third pixels PX1 and PX3 is changed to the white gray scale in the second row ROW2 from the black gray scale in the first row ROW1, the variation rate of the brightness of the second pixel PX2 arranged in the second row ROW2 may be the greatest variation rate.

Accordingly, when the gray-scale level of the first and third pixels PX1 and PX3 is changed to the gray-scale level between the black and white gray-scale levels in the second row ROW2 from the black gray scale in the first row ROW1, the variation rate of the brightness of the second pixel PX2 arranged in the second row ROW2 may be less than the variation rate of the brightness of the second pixel PX2 shown in FIGS. 8 to 11.

The first, second and third distances D1, D2 and D3 are set such that the variation rate of the brightness of the pixel PX arranged in the second row ROW2 and the second column COL2 is in a range from about +2% to about −2%. The first, second and third distances D1, D2 and D3 of the black matrix BM will be described later in greater detail.

The graphs shown in FIG. 8 represent the variation rate of the brightness of the pixel PX with respect to the distance in the first direction X1 between the pixel electrodes PE adjacent to each other and the width of the black matrix BM when the pixels PX are driven in the row-inversion driving manner and the liquid crystal layer LC is the negative liquid crystal layer.

Referring to FIG. 8, the variation rate of the brightness of the second pixel PX2 in the second row ROW2 may be in the range from about +2% to about −2% when the pixels PX are driven in the row-inversion driving manner and the liquid crystal layer LC is the negative liquid crystal layer.

When the variation rate of the brightness of the pixel PX is in the range from about +2% to about −2%, a viewer may not perceive the variation in brightness of the pixel PX from an image displayed by the display panel 100. That is, although the brightness of the second pixel PX2 is changed to about 98% to about 102%, the viewer may not perceive the variation in brightness of the pixel PX.

According to the graphs shown in FIG. 8, the distance between the pixel electrodes PE and the width of the black matrix BM may be determined such that the variation in brightness of the second pixel PX2 is not perceived by the viewer.

The distance between the pixel electrodes PE and the width of the black matrix BM are determined with reference to the maximum variation rate of the brightness of the second pixel PX2. Therefore, although the gray-scale level of the first and third pixels PX1 and PX3 is changed to the gray-scale level between the black and white gray-scale levels from the black gray scale, the variation rate of the brightness of the second pixel PX2 may be in the range from about +2% to about −2%.

In an exemplary embodiment, where the pixels PX are driven in the row-inversion driving manner and the liquid crystal layer LC is the negative liquid crystal layer, the distance in the first direction X1 between the pixel electrodes PE adjacent to each other is set to be equal to or smaller than about 14 micrometers, and the width of the black matrix BM is set to be equal to or smaller than about 6 micrometers.

In such an embodiment, the first distance D1 is equal to or smaller than about 14 micrometers, and the second and third distances D2 and D3 are equal to or smaller than about 6 micrometers, such that the variation rate of the brightness of the second pixel PX2 may be minimized to within the range from about +2% to about −2%. In such an embodiment, the variation rate of the other pixels PX, except for the second pixel PX2, may be minimized to within the range from about +2% to about −2%.

The graphs shown in FIG. 9 represent the variation rate of the brightness of the pixel PX with respect to the distance in the first direction X1 between the pixel electrodes PE adjacent to each other and the width of the black matrix BM when the pixels PX are driven in the row-inversion driving manner and the liquid crystal layer LC is the positive liquid crystal layer.

Referring to FIG. 9, when the distance in the first direction X1 between the pixel electrodes PE adjacent to each other is equal to or larger than about 10.6 micrometers and the width of the black matrix BM is equal to or larger than about 4 micrometers, the variation rate of the brightness of the second pixel PX2 may be in the range from about +2% to about −2%.

In an exemplary embodiment, where the pixels PX are driven in the row-inversion driving manner and the liquid crystal layer LC is the positive liquid crystal layer, the first distance D1 is equal to or larger than about 10.6 micrometers and the second and third distances D2 and D3 are equal to or larger than about 4 micrometers, such that the variation rate of the brightness of the second pixel PX2 may be minimized to within the range from about +2% to about −2%. In such an embodiment, the variation rate of the other pixels PX, except for the second pixel PX2, may be minimized to within the range from about +2% to about −2%.

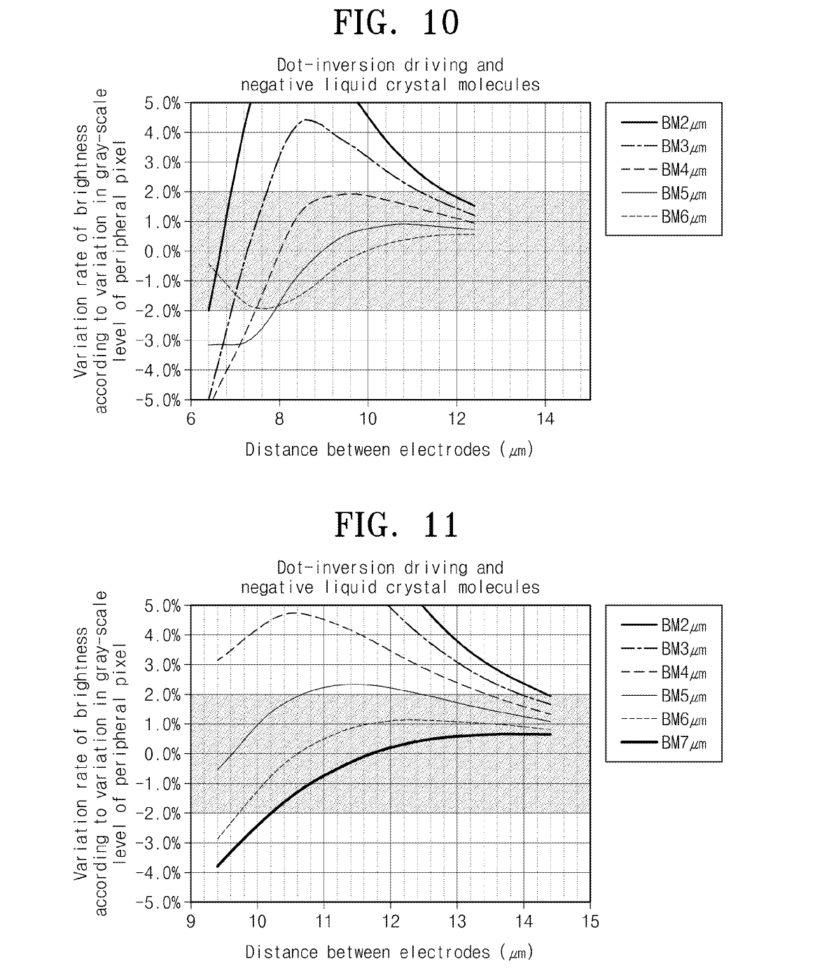

The graphs shown in FIG. 10 represent the variation rate of the brightness of the pixel PX with respect to the distance in the first direction X1 between the pixel electrodes PE adjacent to each other and the width of the black matrix BM when the pixels PX are driven in the dot-inversion driving manner and the liquid crystal layer LC is the negative liquid crystal layer.

Referring to FIG. 10, when the distance in the first direction X1 between the pixel electrodes PE adjacent to each other is equal to or larger than about 8 micrometers and the width of the black matrix BM is equal to or smaller than about 6 micrometers and equal to or larger than about 4 micrometers, the variation rate of the brightness of the second pixel PX2 may be in the range from about +2% to about −2%.

Accordingly, in an exemplary embodiment, where when the pixels PX are driven in the dot-inversion driving manner and the liquid crystal layer LC is the negative liquid crystal layer, the first distance D1 is equal to or larger than about 8 micrometers and the second and third distances D2 and D3 are equal to or smaller than about 6 micrometers and equal to or larger than about 4 micrometers, such that the variation rate of the brightness of the second pixel PX2 may be minimized to within the range from about +2% to about −2%. In such an embodiment, the variation rate of the other pixels PX, except for the second pixel PX2, may be minimized to within the range from about +2% to about −2%.

The graphs shown in FIG. 11 represent the variation rate of the brightness of the pixel PX with respect to the distance in the first direction X1 between the pixel electrodes PE adjacent to each other and the width of the black matrix BM when the pixels PX are driven in the dot-inversion driving manner and the liquid crystal layer LC is the positive liquid crystal layer.

Referring to FIG. 11, when the distance in the first direction X1 between the pixel electrodes PE adjacent to each other is equal to or larger than about 12.6 micrometers and the width of the black matrix BM is equal to or smaller than about 7 micrometers and equal to or larger than about 5 micrometers, the variation rate of the brightness of the second pixel PX2 may be in the range from about +2% to about −2%.

Accordingly, in an exemplary embodiment, where the pixels PX are driven in the dot-inversion driving manner and the liquid crystal layer LC is the positive liquid crystal layer, the first distance D1 is equal to or larger than about 12.6 micrometers and the second and third distances D2 and D3 are equal to or smaller than about 7 micrometers and equal to or larger than about 5 micrometers, such that the variation rate of the brightness of the second pixel PX2 may be minimized to within the range from about +2% to about −2%.

Referring to FIG. 11, when the distance in the first direction X1 between the pixel electrodes PE adjacent to each other is equal to or larger than about 10.2 micrometers and equal to or smaller than about 10.6 micrometers and the width of the black matrix BM is equal to or smaller than about 7 micrometers and equal to or larger than about 5 micrometers, the variation rate of the brightness of the second pixel PX2 may be in the range from about +2% to about −2%.

Accordingly, in an exemplary embodiment, where the pixels PX are driven in the dot-inversion driving manner and the liquid crystal layer LC is the positive liquid crystal layer, the first distance D1 is equal to or larger than about 10.2 micrometers and equal to or smaller than about 10.6 micrometers and the second and third distances D2 and D3 are equal to or smaller than about 7 micrometers and equal to or larger than about 5 micrometers, such that the variation rate of the brightness of the second pixel PX2 may be minimized to within the range from about +2% to about −2%.

In such an embodiment, the variation rate of the other pixels PX, except for the second pixel PX2, may be minimized to within the range from about +2% to about −2%.

The description on the above explains the experimental result about the pixels PXij having the structure shown in FIG. 2. As similar to the pixel PXij, the first, second and third distances D1, D2 and D3 may be set such that the variation rate of the brightness of the pixel PX with respect to the variation in brightness of the peripheral pixels PX is in the range from about +2% to about −2% in the pixels PX, each including the pixel electrode PE shown in FIGS. 3A and 3B.

Accordingly, in an exemplary embodiment, the display device 500 may minimize the variation rate of the brightness of the pixel PX with respect to the variation in the gray-scale level of the peripheral pixel PX.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A display device comprising:
a display panel comprising a plurality of pixels arranged substantially in a matrix form;
a plurality of pixel electrodes disposed in pixel areas corresponding to the pixels, arranged at a first distance from each other along a first direction, and extending in a second direction crossing the first direction; and
a black matrix disposed in a non-pixel area disposed adjacent to each pixel area,
wherein
a width of the black matrix and the first distance are set to allow a variation rate of a brightness of each pixel arranged in a same pixel column and a pixel row to be in a range from about +2% to about −2% when a gray-scale level of the pixels respectively disposed at left and right sides of each pixel arranged in the same pixel column is changed to a different gray-scale level in the pixel row from a gray-scale level in a previous pixel row, and
the width of the black matrix is defined as a width of the black matrix between the pixel areas in the first direction or the second direction.

2. The display device of claim 1, wherein a gray-scale level of each pixel arranged in the same pixel column and in the pixel row is equal to a gray-scale level of each pixel arranged in the same pixel column and in the previous pixel row.

3. The display device of claim 1, wherein each of the pixel electrodes comprises a branch portion extending in the second direction and disposed at a center of the pixel area.

4. The display device of claim 3, wherein the display panel comprises:
a first substrate, on which the pixels are arranged;
a second substrate comprising color filters corresponding to the pixels and the black matrix, wherein the black matrix is arranged on the second substrate; and
a liquid crystal layer disposed between the first substrate and the second substrate.

5. The display device of claim 4, wherein
the pixels receive positive and negative data voltages in response to gate signals sequentially applied thereto and are driven in the unit of row, and
a polarity of the pixels is inverted in the unit of row.

6. The display device of claim 5, wherein
the liquid crystal layer comprises negative liquid crystal molecules,
the first distance is equal to or smaller than about 14 micrometers, and
the width of the black matrix is equal to or smaller than about 6 micrometers.

7. The display device of claim 5, wherein
the liquid crystal layer comprises positive liquid crystal molecules,
the first distance is equal to or larger than about 10.6 micrometers, and
the width of the black matrix is equal to or larger than about 4 micrometers.

8. The display device of claim 4, wherein
the pixels receive positive and negative data voltages in response to gate signals sequentially applied thereto and are driven in the unit of row, and
a polarity of the pixels is inverted in row and column directions.

9. The display device of claim 8, wherein
the liquid crystal layer comprises negative liquid crystal molecules,
the first distance is equal to or larger than about 8 micrometers, and
the width of the black matrix is equal to or smaller than about 6 micrometers and equal to or larger than about 4 micrometers.

10. The display device of claim 8, wherein
the liquid crystal layer comprises positive liquid crystal molecules,
the first distance is equal to or larger than about 12.6 micrometers, and
the width of the black matrix is equal to or smaller than about 7 micrometers and equal to or larger than about 5 micrometers.

11. The display device of claim 8, wherein
the liquid crystal layer comprises positive liquid crystal molecules,
the first distance is equal to or larger than about 10.2 micrometers and equal to or smaller than about 10.6 micrometer, and
the width of the black matrix is equal to or smaller than about 7 micrometers and equal to or larger than about 5 micrometers.

12. The display device of claim 11, wherein each of the pixel electrodes comprises:
a plurality of branch portions arranged in the first direction at regular intervals and extending in the second direction; and
a first connection portion which connects lower portions of the branch portions to each other.

13. The display device of claim 1, wherein each of the pixel electrodes comprises:
a plurality of branch portions arranged in the first direction at regular intervals and extending in the second direction;
a first connection portion which connects first ends of the branch portions to each other in the second direction; and
a second connection portion which connects second ends of the branch portions to each other in the second direction.

14. The display device of claim 1, wherein
a second distance defined by the width of the black matrix between the pixel areas in the first direction is equal to or smaller than a third distance defined by the width of the black matrix between the pixel areas in the second direction.

15. The display device of claim 1, wherein each of the pixels comprises:
a thin film transistor connected to a corresponding pixel electrode of the pixel electrodes;
an organic insulating layer disposed to cover the thin film transistor;
a common electrode disposed on the organic insulating layer, wherein an opening portion is defined in the common electrode; and
an inorganic insulating layer disposed on the organic insulating layer to cover the common electrode,
wherein
the pixel electrodes are disposed on the inorganic insulating layer,
the corresponding pixel electrode is connected to the thin film transistor through a contact hole defined through the organic insulating layer and the inorganic insulating layer, and
the opening portion overlaps the contact hole and has a size greater than a size of the contact hole when viewed in a plan view.
